(19) United States
(12) Patent Application Publication
(10) Pub. No.: US 2024/0265473 A1
(43) Pub. Date: Aug. 8, 2024

(54) SYSTEM AND METHOD OF BLOCKCHAIN ENABLED SOCIAL PLATFORM ECOSYSTEM TO COLLECT, CREATE, STORE, PROCESS, AND DISTRIBUTE DATA, DIGITAL CONTENTS, DIGITAL ASSETS AND DIGITAL IDENTITIES, USING ARTIFICIAL INTELLIGENCE, SMART CONTRACTS, INSTRUCTIONS, CONDITIONS AND TRIGGERS

(71) Applicant: EVERZ INC, Bethesda, MD (US)

(72) Inventor: Faraz FARZANFAR, Bethesda, MD (US)

(21) Appl. No.: 18/431,137

(22) Filed: Feb. 2, 2024

Related U.S. Application Data
(60) Provisional application No. 63/482,903, filed on Feb. 2, 2023.

(51) Int. Cl. G06Q 50/00; H04L 9/00

(52) U.S. Cl. CPC G06Q 50/01; H04L 9/50

(57) ABSTRACT

A platform governed by user instructions, artificial intelligence (AI) and artificial consciousness of a user, utilizing blockchain enabled pods that may contain any type of data, digital assets, AI, smart contracts or instructions which enables users to create AI agents from their data as eternal digital identity to follow instructions, perform future actions and represent user as a digital clone. Blockchain-enabled virtual data containers referred to herein as pod, can contain any type of data like images, music, audio and video materials, drawings, documents, application programming interfaces (API), non-fungible tokens (NFT), algorithms, digital assets, cryptocurrency, computer programs and other contents created, owned by or otherwise associated with the user. Pods are managed by user instruction and conditions using AI agents created from user data and may store data or be used as data management as well as virtual space for AI to AI interactions to create new algorithms, instruction, data, digital assets and new pods.

### CROSS REFERENCE TO RELATED APPLICATIONS

The present application claims benefit of provisional application Ser. No. 63/482,903, filed Feb. 2, 2023, the contents of which are incorporated herein by reference.

### FIELD OF THE INVENTION

This present invention relates to a blockchain enabled social ecosystem that is used for collection, creating, storing, managing and processing data, digital contents, digital assets, digital identities, Artificial Intelligence (AI) and other computer programs and distributing to receivers based on user instructions and fulfillment of a set of conditions, smart contracts and triggers, as well as creating blockchain digital assets and NFTs, AI agents, digital marketplace and programs to control IoT devices, Drones and Robots.

### SUMMARY OF THE INVENTION

Evers is an ecosystem and platform governed by User instructions, Artificial Intelligence and Artificial Consciousness of user, utilizing blockchain enabled pods that may contain any type of data, digital assets, AI, smart contracts or instructions which enables users to create AI Agents from their data as eternal digital identity to follow instructions, perform future actions and represent user as a digital clone. Blockchain enabled virtual Data containers referred to herein as Pod, can contain any type of data like images, music, audio and video materials, drawings, documents, application programming interfaces (API), non-fungible tokens (NFT), algorithms, digital assets, cryptocurrency, computer programs and other contents created, owned by or otherwise associated with the user. Pods are managed by user instruction and conditions using AI agents created from user data and may store data or be used as data management as well as virtual space for AI to AI interactions to create new algorithms, instruction, data, digital assets and new pods.

### BRIEF DESCRIPTION OF THE DRAWINGS

FIG. 1 is a flowchart depicting the components and relationships of the EVERS Platform/Ecosystem and EVERS POD.

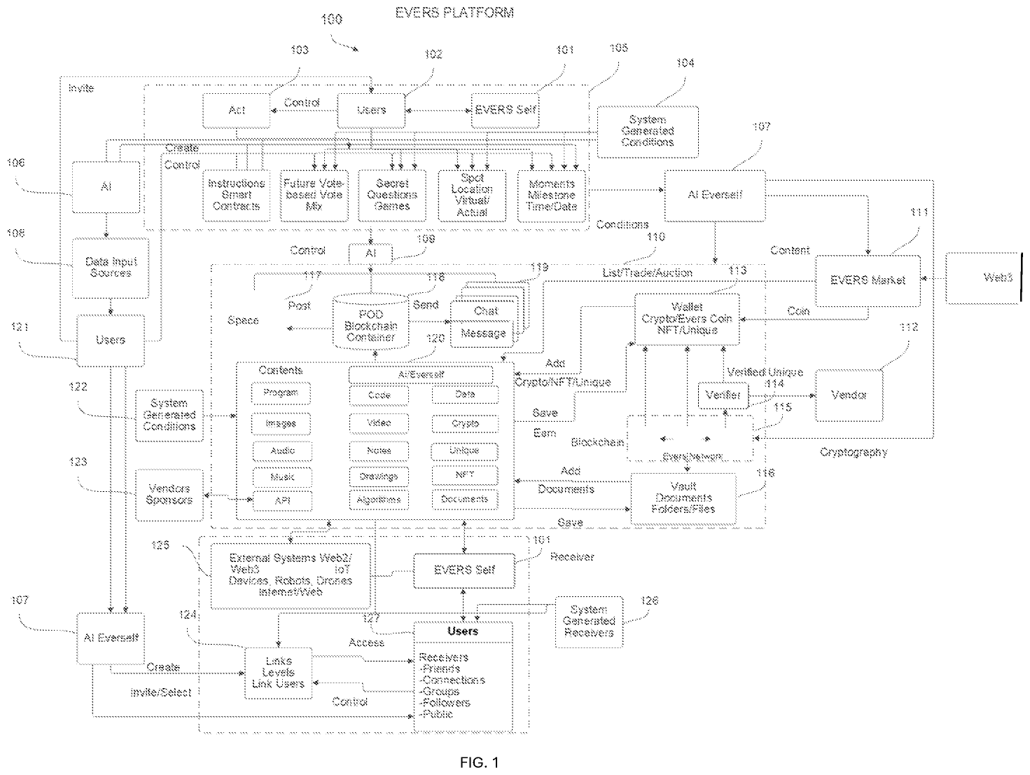

FIG. 2 is a flowchart depicting the components and process of EVERS Condition, Future, Spots, Moment and Act.

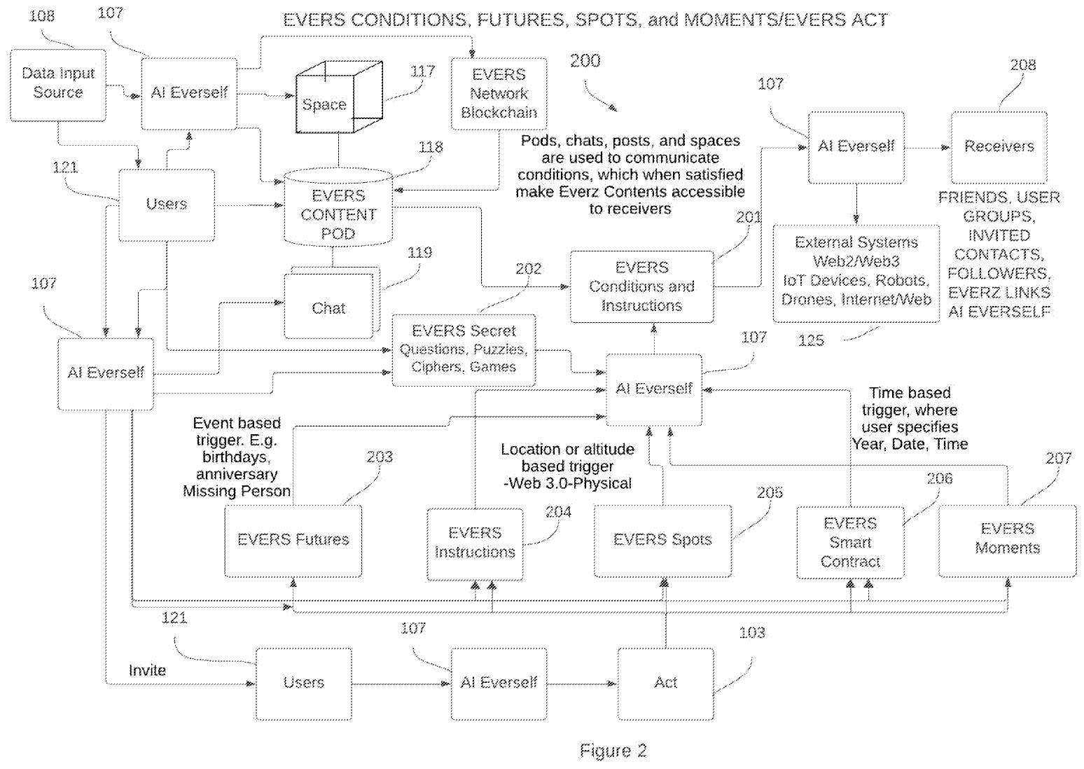

FIG. 3 is a flowchart depicting the components and process of EVERS Coin/Unique/Wallet.

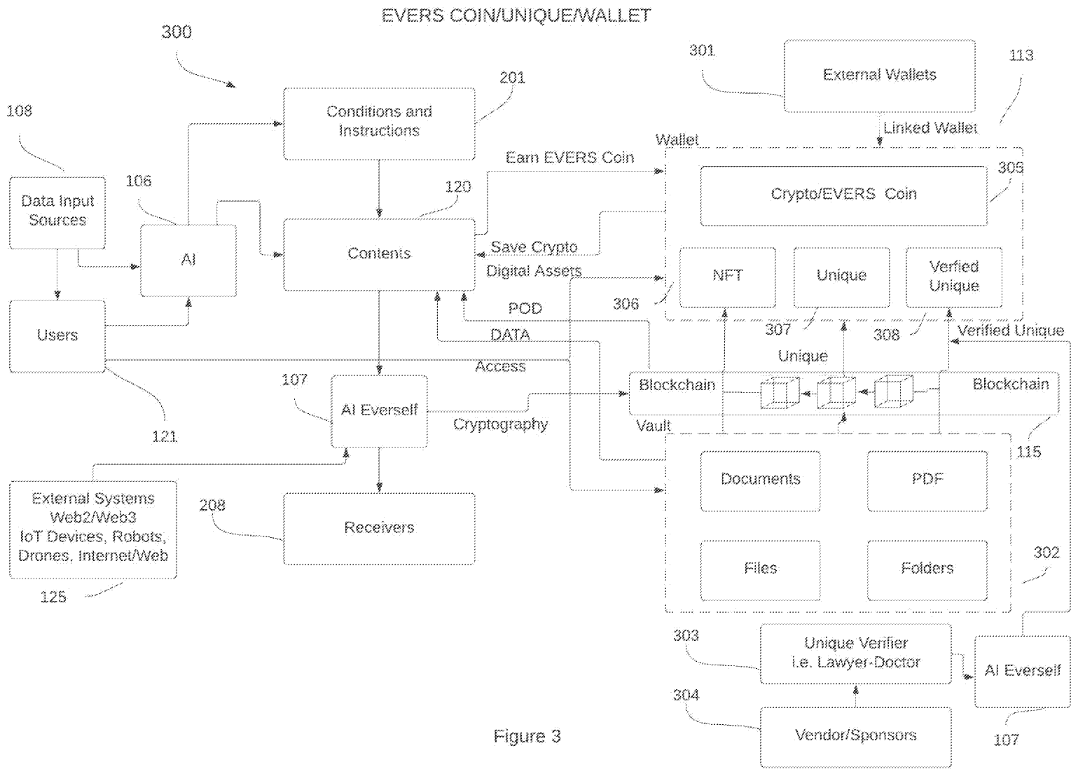

FIG. 4 is a flowchart depicting the components and process of EVERS Link.

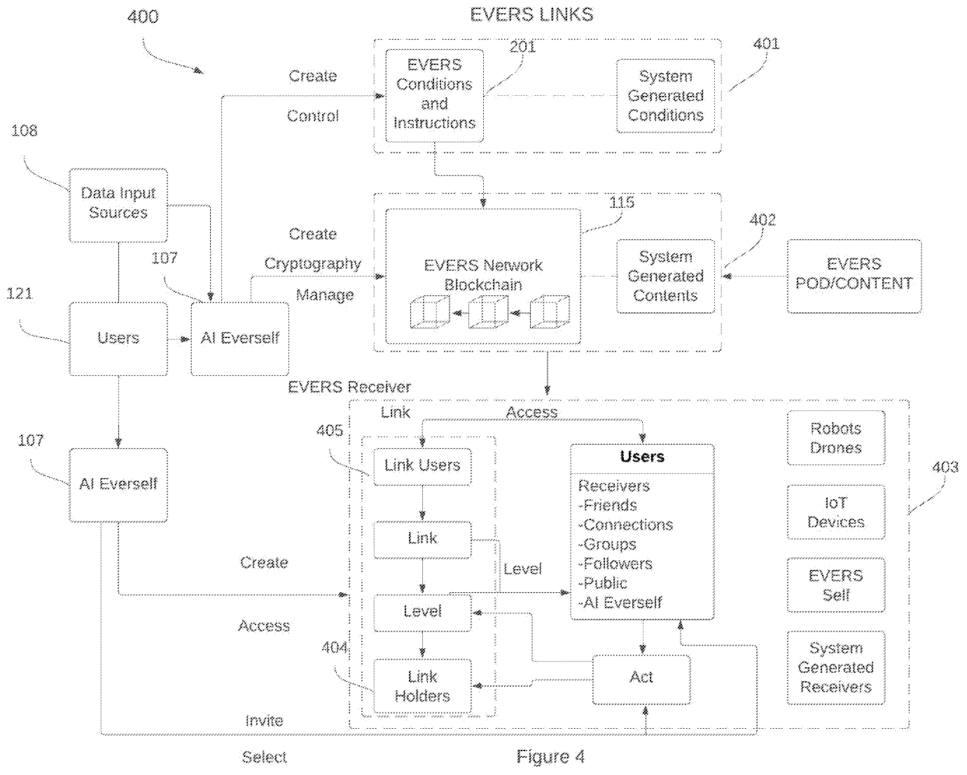

FIG. 5 is a flowchart depicting the components and process of EVERSELF/METEVERS.

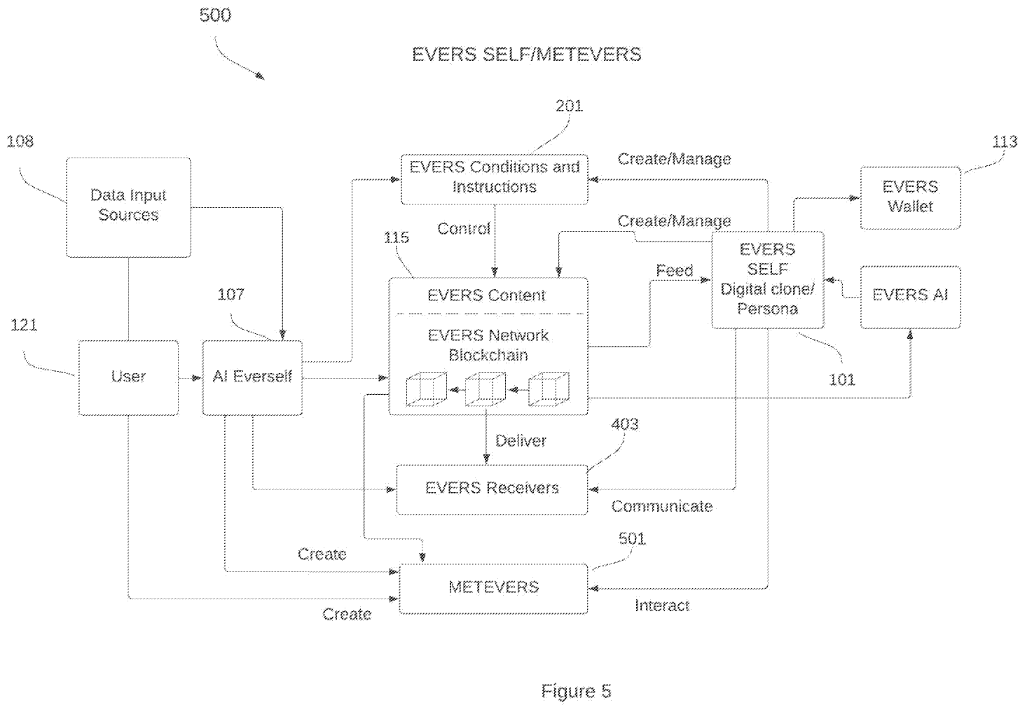

FIG. 6 is a flowchart depicting the components and process of EVERS Space.

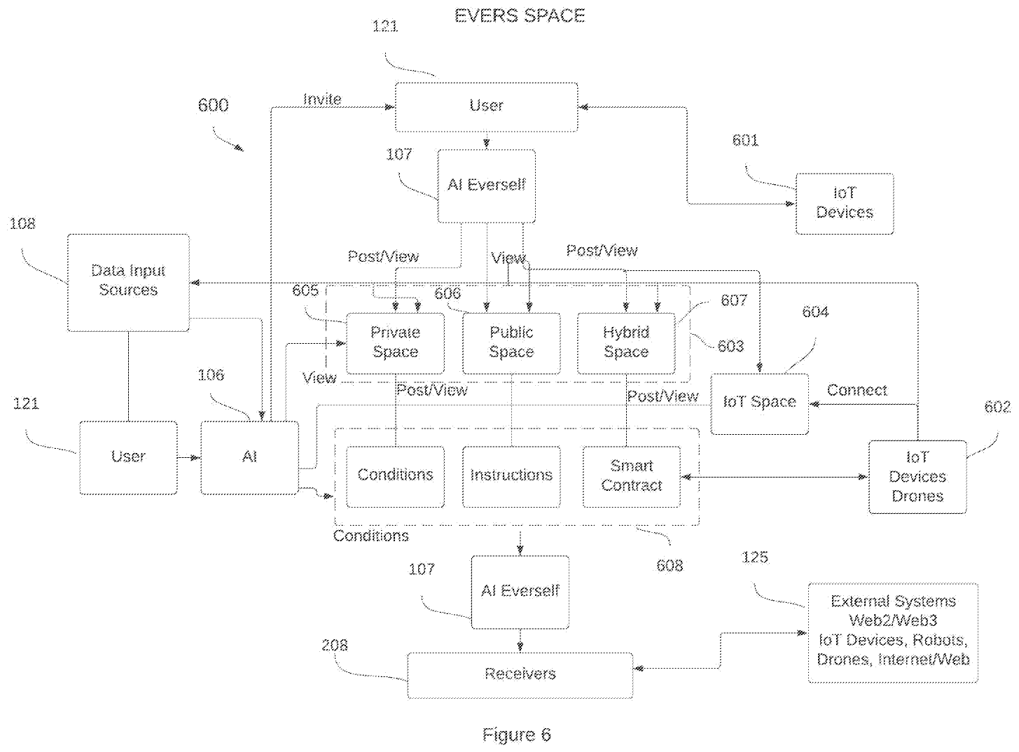

FIG. 7 is a flowchart depicting the components and process of EVERS Spot/Secret.

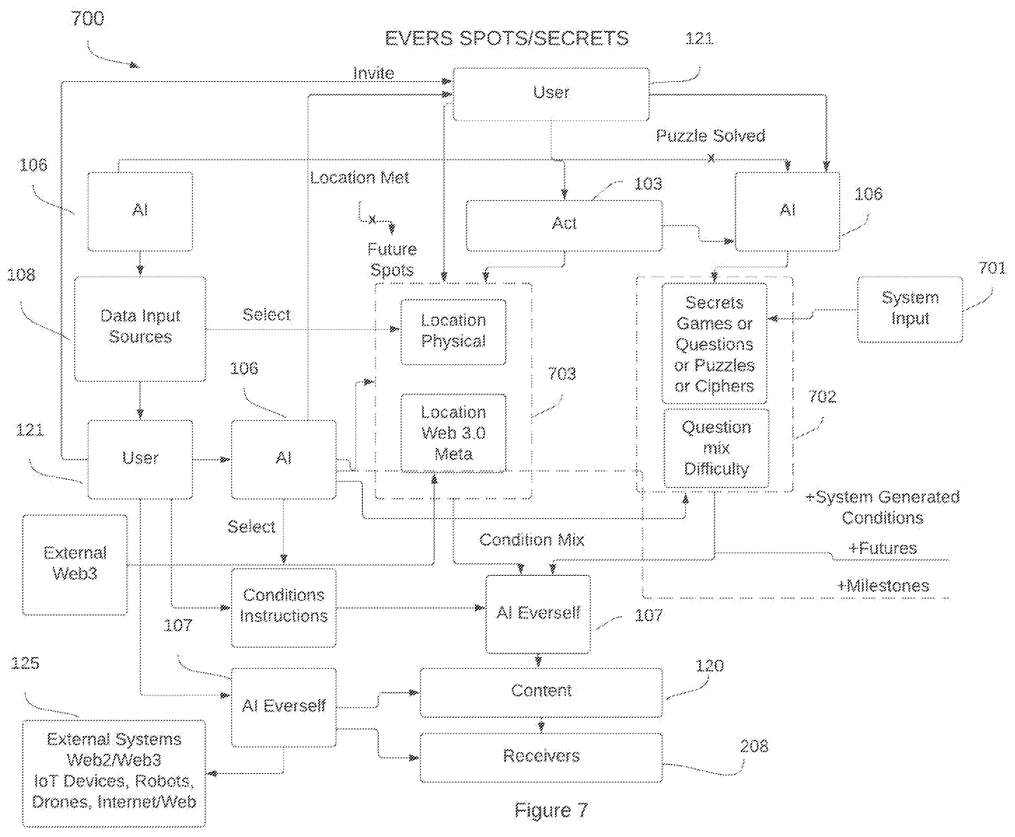

FIG. 8 is a flowchart depicting the components and process of EVERS Conditions Future/Milestone/Moment.

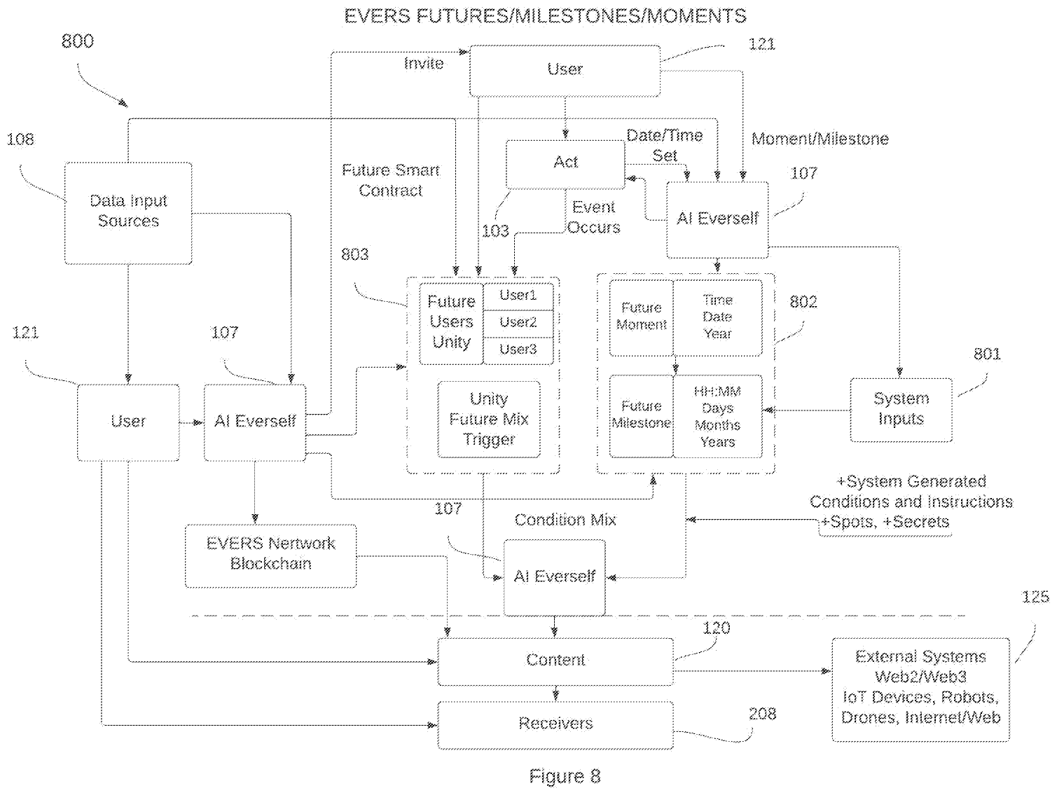

### DETAILED DESCRIPTION OF THE INVENTION

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

Referred to commercially as Evers, the ecosystem (platform) 100 provides solutions for collecting, creating, storing, securing, processing, and distributing digital content 120 described above as well as digital assets and NFTs, physical goods storage and shipment orders, and algorithms including Internet of Things (IoT) 125 and artificial intelligence (AI) Agents algorithms and controllers. The ecosystem 100 combines technologies including Cloud Computing, Blockchain, Smart Contracts, Social Networking, Data Mining, Internet of Things (IoT), Machine Learning, Artificial Intelligence, Quantum Resistant Cryptography, Extended Reality (XR), Virtual Reality (VR), Augmented Reality (AR), Mixed Reality (MR), Data Visualization, Generative and Interactive AI, Natural Language Processing (NLP), Biometric Authentication, Data Analytics, Robotic Automation and Geolocation.

Pod 118 is one of the main components of Evers ecosystem 100. Users 102, 121 or AI Agents can create Pods 118 to store a variety of contents and data types to be distributed to selected users or groups upon meeting predefined conditions or instructions 104, 105. Users can create and store Pods 118 privately under their user account or distribute them to other users or AI 127, 101 based on their privacy requirements and secured conditions and instructions 104, 105.

Users 102, 121 may also make their pods 118 visible and accessible to various user groups 127 including followers, connections, circles, friends and invited contacts that meet certain conditions. Users can also save public or private Pods they receive from other users and access them within their profile or share Pods 118 to be accessed from other platforms and ecosystems.

Users 121 also may decide to show or hide Pod previews to or from receivers before predefined conditions are met. Pods 118 may receive likes, and comments and can be shared inside other pods, chats or posts or outside through links or posts on other platforms.

User data is collected through user smartphones, smart devices, smart glasses, sensors, IoT devices, drones, and other digital capturing and recording devices 108 that can connect to the platform, and cloud or blockchain storages 115. User data is stored in military grade encrypted blockchain enabled secure cloud servers utilizing most secure cryptography reinforced by AI using the Conditions and Instructions 107, 115,.

Stored data is processed using machine learning to provide data analytics and to help create a user-specific AI machine and Digital Clone referred to as Everself 101, 107. Stored user data and created AI Agents and machines may be distributed to Evers Receivers through Evers System Social Networking technology (Follower/Following/Network/Circles)127, in various forms including Pods 118, chats, posts, and spaces 117,119 upon meeting predefined conditions and instructions 105. The AI Agent or Everself 107 may be utilized to Govern and control the management of this process based on User inputs, instruction and Conditions 104,105.

Evers Contents 120 are any Data Type including digital contents, digital assets and Digital/AI identities that are stored in the Pods. The contents may be images, voice, video, drawing, notes, documents that can be stored securely in cloud storage called Evers Vault 116. Digital assets 113 that can be stored in the Pods may be Blockchain Evers and Pod Coins and Tokens, Evers Unique, Evers Verified Unique, Evers Non-Fungible Tokens (NFT), Evers Digital Clone that is created by Evers AI using user data, and other digital assets including cryptocurrency and NFTs that may be stored in Evers Wallet.

Evers Contents 120 also comprises digital orders for physical goods purchase or shipment or other services provided to users through Evers APIs that may be offered by Evers Sponsors and vendors 112. Artificial intelligence machines and algorithms stored and transferred in Evers may be executed by Evers IoT devices, drones, and robots 125. Evers Receivers 403 may access Pods containing data that can be stored privately by users in their profiles or distributed to individual users, groups, followers, connections, friends, Circles, Evers Links 124 (Users that will be selected later by the Links Holders), and Public which may be all users on or off the Evers Platform 100. These may be accessible upon meeting one or a combination of certain instructions, predefined conditions and triggers 104,105. Evers users may invite existing users or invite new users from their contacts to receive Pods, posts or chats upon joining if condition is met, as well as AI Agents which may also create Pods.

Evers Links 124, 405 are proprietary, special contact types that users create to communicate with unknown users (such as unborn users) to be linked to the actual user 121 once the identity of the unknown user becomes known as Evers user in the future through Evers link holders 404. Each Evers may have Levels (indicating the level current holders are and the last level linking to the final user), Link holders (Evers users or AI Agents that can manage links), and Link users 405 who are invited to access the Evers Link as a contact type.

Evers Conditions 200 and User Instructions control the delivery of Evers Contents 120 and Pods 118 communicated through various methods (chats, posts, and spaces) to become accessible (delivered) to receivers upon meeting one or a combination of predefined or newly created conditions or Instructions.

Evers Futures Unity 203 are event-based conditions created by the users in advance or while creating Evers with user instruction and utilizing AI Agent as event conditions to control Contents and Pod delivery. Evers Futures Unity 203, 803 works like smart contracts managed by triggers controlled by other existing or invited users or AI Agents by accepting and later initiating triggers called Acts 103 to activate future event access conditions. The Futures Unity can receive Act 103 trigger inputs from one or many users or AI Agents that dictate how delivery of Evers Content 120 is managed by AI once that event has occurred.

Users receiving Evers Acts 103 for Evers Futures Unity 203 and other Conditions may choose to accept or deny the Evers Acts 103. This process is being controlled by AI/Everself 107 based on the Users input. Users can choose to auto-accept, manually review or use AI/Everself 107 to manage the Act 103 invitations.

Upon accepting an Evers Act 103, users receive a new Act handler on the Evers Ecosystem 100 which may have instructions on when to activate it, provided by the Future Unity Act creator. If Multiple users are selected to receive Evers Acts 103 to activate a Future event, users may choose the Acts' Mix, which is a vote-based smart contract system that governs the number of Evers Acts required to activate the Future event. This process is governed by AI and Evers Acts 103, and once conditions are met associated with Evers Contents 120 that may be Pods 118, chats, posts or spaces are delivered to nominated users. To action Future events, Evers system 100 and AI only count active Evers Acts 103 which have been accepted by Users or AI agents to be counted towards the Evers Acts Mix managed by AI Agent and Everself 107.

Users may also choose a weight for each Evers Act 103 by selecting the importance of Evers Acts Holder that will be handled by users, so in the mix it is counted by the weight which may be considered more than one user. Users may also associate rewards for the Evers Acts 103 using Evers Coin and tokens 113 which will be managed by AI Agent and Everself 107 and delivered to the Evers Acts 103 holders upon actioning the Evers Act.

Examples of Evers Future Unity 803 Act Triggers Mix may be:
a) All (Require input from 100% of Active Evers Act Trigger Holders)
b) Most (Require input from 50% and above of Active Evers Act Trigger Holders)
c) Some (Require input from 25% and above of Active Evers Act Trigger Holders)
d) Any (Require input from only One Active Evers Act Trigger Holder)

Evers Futures Moment 207 is another type of events that may have a specific date and time as well as duration as milestones based on a specific date such as birthdays or anniversaries. Milestones start date may be set by a user or may be entered later by Act inputs by another user or AI Agent/Everself 107 and may be chosen by Evers users or be calculated automatically through Machine Learning, Artificial Intelligence or information available in Evers Ecosystem or publicly available on the Internet.

Each Evers Future Moment 207 may have Source Date, and Duration 802 which may be user inputs or automated. Future Moment may use the User 121, Evers System 100 or AI Agent inputs for the source date and the Milestone set by user, or automatically generated by the system, to action the Future Moment as content delivery condition for AI agent/Everself 107.

Evers Futures 207 can have Future Act Holders which may be contacts, invitees, and other Evers users 121, Evers Links 124 or AI Agents with Future Act Holders Status as Pending, Active, Rejected or Revoked. Futures will also have Future Act Rewards (Evers Coin) and Future Act Weight (Value of Evers Act as number of users).

Evers Secrets 702 are Security conditions that are created by users in advance or while creating Evers Content through the Secrets section of the Evers Ecosystem. Secrets can be added for an extra level of Data security as conditions to control Evers content delivery. Users may create different secrets using biometric verifications, Puzzles, games, challenges or questions and question types and choose required answers, answer types and the difficulty linked to each question/puzzle or the entire Secret. Secrets may also be generated automatically through artificial intelligence algorithms using User inputs or information available in the Evers Ecosystem 100 or created and managed by AI Agent/Everself 107 and applied to Evers Contents 120 as delivery conditions.

Evers Spots 205 are Geo Location based or Virtual Reality Location conditions that are created by users or AI Agent/Everself 107 in advance or while creating Evers Content 120, Pod 118 or Chat within Evers Ecosystem 100 and can be used as conditions to control Evers Contents 120 delivery by AI Agent/Everself 107.

Evers Spots 205 location conditions are caret by users through choosing a physical or virtual Reality location on the map or using a location identifier and can also have altitude and can be used as Evers content's delivery conditions. Users may also use GPS coordinates, latitude/longitude, for the location as well as a radius that should be applied to the Spot and altitude. The location can also be a virtual reality or MetEvers 501 location identified through web3.0 navigation systems. This may allow the created Spots to be used as conditions to control Evers Contents Delivery by AI Agent/Everself 107. Users 121 may also require other Evers users 121, Evers System, AI Agent or Link contact to nominate the physical or virtual location for Spots 205.

Evers Acts 103 are triggers to control various actions and conditions within the Evers Ecosystem 100 that may control Evers Contents' Delivery Condition used by AI/Everself 107. Evers Acts 103, which are accessible through the Evers Ecosystem 100, may be used by Evers System and AI Agent to control various Actions including Evers Futures Unity 207, Evers Secrets 702, Evers Spots 205, Evers Links 124, Evers Future Moments 203 or other Evers Operations and Conditions that require User or AI Agent Inputs or Actions. Users can choose to auto-accept or manually Accept/Reject different types of Evers Acts.

Evers Chats 119 are personalized communication channels that allow users to exchange Evers Contents 120 and Pods 118 with other individual users, groups of users, or Evers Links 124 (Unknown Users), or AI Agents/Everself 107, containing digital Content, Assets, AI Agents or Pods which become available upon meeting predefined user or AI Conditions and Instructions.

Evers Ecosystem Currency is called Evers Pod Coin 305 which is a blockchain multi-chain smart contract token (cryptocurrency) on the Evers Network which users or AI Agents/Everself 107 can purchase or earn (mine) as rewards for conducting various activities within the Evers ecosystem including but not limited to creating pods, inviting Users, and giving/receiving likes, training Everself based on the predefined value (in Evers Coin) of each activity. Evers Coins 305 can also be purchased using fiat currency (like USD) or crypto assets (like Ethereum) which may be stored in Evers Wallet 113. Evers Coin 305 also can be traded on cryptocurrency exchanges for other digital assets or sold for fiat money. Evers Coins 305 can be used as the payment method to receive various services offered including but not limited to creating and trading Evers Unique 307, Evers Verified Unique 308, Evers NFT 306, and any other services or transactions offered within the Evers ecosystem by Evers, Sponsors or other Vendors and service providers 304.

Evers Vault 302 is secured cloud storage on Evers Cloud for storing and managing digital contents that is accessible through the Evers Ecosystem and used to create and train AI Agents/Everself 107. Through Evers Vault 302 users can create folders, upload files and view uploaded files and saved files from other Pods, chats, posts and spaces. Files available in the Vault can be selected to be converted into blockchain and smart contract digital assets including Evers Unique 307, Evers Verified Unique 308, Evers NFT 306. Files stored in Evers Vault 302 can be included in Evers Pods 118, Chats 119 or Spaces, transferred to other Users, or stored in their Evers Vault 302 upon accessing Pods, Chats, and Spaces.

Evers Unique 307 is a digital asset created on Evers multichain hybrid blockchain network using smart contracts technology on Evers blockchain network 115. Users 121 or AI Agents/Everself 107 can create Evers Unique 307 from files stored in their Evers Vault 302 and pay for it using the Evers Coins 305. Evers Unique 307 is stored in the Evers Wallet 113 as digital assets and can be included in Evers Pods 118, Chats 119 or Spaces, transferred to other Users or AI Agents/Everself 107, or stored in their Evers Wallet 113 upon accessing Pods, Chats, Posts, or Spaces and also can be Traded or Auctioned in the Evers Market 111. Users 121 can also convert each Evers Unique 307 to Evers Verified Unique 308 or Evers NFT 306 which all can be also stored in their Evers Wallet 113. This process is controlled by AI/Everself 107 based on Users inputs.

Evers Verified Unique 308 is similar to Evers Unique 307 but with added verification by subject matter experts or Authorized AI and is created from files available in Evers Vault 302 or Existing Evers Uniques 307 in the Evers Wallet 113, and will require the file, documents or Evers Unique to be reviewed and verified/approved by a professional such as a lawyer, a doctor, an accountant, AI Agents or other verifier who will receive Evers coins 305 for their services upon Evers Verified Unique 308 creation. Evers Verified Uniques 308 are stored in Evers Wallets 113 and can be distributed as digital assets through Pods, Chats, Posts and Spaces and can be stored in other user Wallets or traded as Digital Asset in Evers market using blockchain technology and this process is controlled by AI Agents/Everself 107 based on Users inputs.

The professional Verifier 303 or AI may be paid for the verification service using Evers Coin 305, another cryptocurrency, or fiat currency and the smart Contract is paid for using Evers Coin 305 or another cryptocurrency, to convert specific files into a special type of Evers Unique (Evers Verified Unique), which is stored in the Evers Wallet 113 as a Verified Digital Asset and can be transferred within Evers Platform 100, traded or Auctioned in Evers Market 111.

Evers NFT 306 is Non-Fungible Token Digital Asset that users create from files stored in their Evers Vault 302, or Evers Unique 307 and Evers Verified Unique 308 stored in their Evers Wallet 113 and pay for using Evers Coin 305 or another cryptocurrency. Evers NFTs 306 will be stored in the User Evers Wallet and may be transferred to any other crypto wallet (like MetaMask or Trust Wallet) and traded or auctioned in the Evers Market 111 or other NFT marketplaces.

Evers Wallet 113 is a blockchain enabled digital wallet capability of Evers Ecosystem 100. Evers Wallet 113 is a place where users can store and manage any digital assets and fiat currencies as well as managing payment methods and viewing transaction history. Through Evers Wallet 113, which may be linked to external crypto wallets and exchanges, users can manage their payment methods, view the balance of their available fiat currency, track payment history, purchase Evers Coin 305 using fiat or cryptocurrencies, store Evers Coin 305 and other blockchain cryptocurrencies, view Evers Coin 305 and other cryptocurrency balance, store, access and transfer Evers Unique 307, Evers Verified Unique 308, Evers NFTs 306, and any other NFTs and/or digital assets, including Everself AI Agent and other blockchain and smart contract based assets. Digital assets purchased, transferred and stored in Evers Wallet may be used to create and train Everself AI Agents and can be included in Evers Pods, chats or spaces, and transferred to other Users to be stored in their Evers Wallets 113 upon getting access, and can be Traded or Auctioned in the Evers Market 111.

Evers Space 117 is another Evers Functionality and Capability which is accessed within the Evers Ecosystem 100. Evers Space 117 is home to Multi Dimension Ecosystem which may contain a wide range of data, digital contents and digital assets that will appear on a specified position of the Screen, Virtual Reality 3D Space Location or Users' linked IoT devices upon meeting Instruction and Conditions set by the Evers Space creator or AI Agents/Everself 107. Each Evers user 121 may have access to different privacy types of Evers Space 117, such as Public Space 606, Private Space 605 or Hybrid Space 607 accessible within Evers Ecosystem 100 by users or AI Agents/Everself 100 or IoT Devices.

Evers Neoz 125 are Programmable IoT enabled Devices, Drones, Robots and machines that can receive their instruction from users or AI Agents/Everself 107 as Evers Contents stored in Pods 118, Chats 119 or Spaces 117 or programmed ahead of time to be executed upon meeting certain conditions. This process is controlled and managed by AI Agents/Everself based on Users inputs and Instructions.

Everself 107 is the Eternal Digital Clone of an Evers user, created from the Evers User's Data using machine learning, capable of acting as an AI Agent Assistant and Governor of the Evers ecosystem. It operates and interacts on Web2 and Web3 platforms as the user's clone in virtual reality as an Avatar or in actual reality using robots. Users retain ownership of their raw and processed data, including Everself 107, through blockchain, smart contracts, and non-fungible tokens (NFTs). Everself also reinforces the Evers blockchain network through the use of conditions, instructions, and advanced quantum-resistant algorithms in Evers network cryptography 115 for fortified security. Everself 107 may be replicated by users and can be transferred as a digital identity or digital asset. Everself 107 may evolve, learn, and communicate with the creator and owner as well as with other users and digital identities, AI agents, or Everself through the Evers ecosystem in Augmented Reality, Virtual Reality, Mixed Reality, and Metaverses as the AI digital identity and clone. Everself will project the user's existence even after the user is no longer living, carrying the wisdom and consciousness of the user as the Eternal existence digital Legacy, communicating within Evers and the outside world in the same way the user would.

Evers Market 111 is a marketplace for Digital Assets such as Evers NFTs 306, Evers Uniques 307, Evers Verified Uniques 308, AI Agents/Everself and all other Digital assets, NFTs and Identities that can be stored, transferred, traded or auctioned within the Evers Market 111.

MetEvers 501 is a Web3 platform created as a virtual reality space, supporting augmented reality, mixed reality or actual reality that will allow Evers users and AI Agents/Everself 107 to access Evers Contents 120 and interact with Evers Platform 100 in the virtual reality Web3 platform, access all Evers functionalities and interact with digital identities like Everself 107 in a virtual reality platform. Some structures and elements of MetEvers 501 which may be programmed to be created or modified ahead of time by users upon or AI Agents/Everself 107 upon meeting conditions and Instructions, are the MetEvers 501 architecture, structures, gravity laws and AI Agents and identities. This process is controlled and managed by user or AI Agents/Everself 107 based on users inputs.

Other features and advantages of the present invention will be apparent from the following more detailed description, taken in conjunction with the accompanying drawings which illustrate, by way of example, the principles of the invention.

What is claimed is:

1. Everself: Everself, also known as Eternal self, is an artificial intelligence entity crafted by accumulating and processing user data, assets and instructions over time. Its purpose is to replicate user's preferences, likes, dislikes, and decision-making processes, essentially forming a virtual persona or digital clone that mirrors the user's evolving identity, behaviors and characteristics, wherein Everself undergoes learning and training based on the data and access provided by the user. It subsequently engages in interactions and assumes control over diverse accesses granted by the user, functioning as an extension of the user's consciousness to interface with the external world, ecosystems, and the broader Evers World and other ecosystems, wherein, the methodology involves processing stored data within the Evers Vault and ecosystem using machine learning, facilitating the creation of a personalized AI entity known as Everself. This AI entity, stored within the Evers Vault, can manifest in Virtual Reality, the metaverse, or various audio/visual or AI-generated environments. It can also be disseminated to other users through Evers System Social Networking technology, utilizing concepts such as Followers and Following, and taking forms such as pods, chats, posts, and spaces, based on instructions and conditions in which it can also manage.

2. As in claim 1, wherein users have the capability to train their own Everself in Evers and Virtual Reality, enabling interactions with their own instance or those of others. Furthermore, Everself can be uploaded onto Internet of Things (IoT) enabled devices, drones, and robots. Everself possesses the ability to generate pods according to user instructions, projecting the user's consciousness for as long as the Everself remains active. Everself reinforces the Evers blockchain network through using conditions, instructions, and quantum-resistant algorithms in Evers network cryptography. Everself will project the user's existence even after the user is no longer living, carrying the wisdom and consciousness of the user as the Eternal existence and digital Legacy, communicating within Evers and the outside world in the same way the user would.

3. POD: A crucial component within the Evers ecosystem is a blockchain-enabled data capsule designed to ensure the integrity and security of data. This versatile capsule, referred to as a ‘pod’ has the capacity to encompass various data types, digital content, digital assets or identities, as well as codes and programs such as instructions for IoT devices, Drones, Robots or AI machines. AI Agent/Everslef manages and governs this blockchain compatible pod, governing its functionality and access, wherein the Pod ecosystem comprised:
blockchain-enabled data capsule called a Pod, that is a distinctive unit created, transferred, connected, or owned by users of the platform. A pod serves as a secure repository for digital assets and are governed by blockchain, ensuring data integrity and security;
decentralized cloud based social ecosystem that facilitates user access, preservation, and transmission of digital content and assets stored within pods. Users can establish various conditions and triggers through smart contracts, dictating the release of data to specific parties under specific AI-controlled conditions.
wherein, Pods can encompass diverse elements, including images, music, audio and video materials, drawings, notes, messages, documents, APIs, NFTs, smart contracts, algorithms, digital assets, and cryptocurrencies—collectively termed as ‘Evers Contents’;
wherein, Pods are blockchain-enabled and can be seamlessly embedded in chats, spaces, and posts. Users can share or distribute their pods within the platform. Pods may contain code, executable files, AI machines and controls, software, information systems, or APIs.
wherein, users can interact with AI by providing data and instructions. AI, in turn, can interact with and control a network of blockchain-enabled data pods. Users, through various data inputs like pictures or camera sources, create pods with sets of conditions.
wherein conditions may be based on location, time, date, moment, or people, and the AI interprets and executes these instructions. This integrated system allows for dynamic interactions between users and AI, empowering users to create, manage, and share data capsules with precision and control.
wherein Pod can act as space for AI to users or groups as well as AI to AI interactions to perform computation, exchange digital assets or create new algorithms, instruction, data, conditions, code, programs, digital assets and new pods.

4. Link: As in claim claim 1, the identification of specific parties associated with a user is determined by AI/Everself, as directed by the Link Holder's instructions. These designated parties, termed as Evers Content Receivers, are chosen from a pool that includes individual users, user groups, followers, connections, friends, Evers Links, and the Public. Users may exist either within or outside the Evers Ecosystem/Platform, wherein within this diverse set, Evers Links hold a distinctive role. These links represent unique contact types established by users for communication with unknown entities, such as those who are yet to join the platform or future generations (unborn users). These links act as a means for connecting with these unknown users in the future once their identity becomes known within the Evers ecosystem. Evers Links can be characterized by link levels, indicating the number of times the link is passed, and link holders who possess the authority to nominate other users to engage with the Evers Link. This process continues until the final user (Level 0) is selected at Level 1, wherein link users, invited by the Link Holder, perceive the Link as their contact for communication, both within and beyond the Evers Ecosystem/Platform. The intricate network of Evers Links, with its hierarchical structure and adaptable communication dynamics, plays a pivotal role in connecting users and facilitating communication based on the evolving identities and relationships within the Evers ecosystem.

5. Future: In accordance with claim 1, the management of delivery conditions for Evers Contents, disseminated through various means such as pods, chats, posts, and spaces, involves making the content accessible to recipients upon the fulfillment of predefined or newly established conditions and triggers, all overseen by AI. This collection of conditions is termed as Evers Conditions and can be added by user, Act or AI/Everself, wherein Evers Future comprises:
future Unity, which are event conditions pre-arranged by users during the creation of Evers contents in the Futures section of the Evers Platform, under the governance of Everself/AI. These Evers Futures operate akin to smart contracts, triggered by other Evers users who accept triggers known as Evers Acts. These Acts serve to activate future events in accordance with a logical consensus algorithm known as the Trigger Mix, as defined by the Condition Creator.
future Moment, which is a time condition set by the user, inclusive of a specified source date and time (year, date, and time) and a milestone duration. AI/Everself utilizes and governs this temporal condition to control the delivery of Evers Contents, starting from the chosen date and time, which can be AI generated or user input through Act triggers, and counting the years, months and days milestone from the source date and time.

6. Spot: In line with claim 1, an additional method for governing the delivery conditions of Evers Contents involves the use of Evers Spots. These are location-based conditions created by users either in advance or during the creation of Evers Content within Pods, Chats, Posts, or Spaces, utilizing the Spots section of the Evers Platform. Evers Spots serve as conditions for AI/Everself to regulate the delivery of Evers Contents.

7. In line with claim 6, Evers Spot comprises:
spot location conditions, where users can create Spot with various attributes, including a title, description, Spot Act Nominator, Geo Location, altitude, and radius. The location itself may pertain to physical real-world geo location coordinates or a virtual reality/metaverse location identified through web3.0 navigation systems;
selection and Nomination, where the main user creating the Spot condition has the option to select specific Spots. Other Evers users, invited to accept and hold the Evers Spot Act, or AI Everself can nominate additional Spots, utilizing live location, web3.0 metaverse location, virtual location, point on the map, or GPS coordinates. These nominations may or may not include altitude, radius, or a description;
Evers Spots, therefore, provide a nuanced approach to controlling the delivery conditions of Evers Contents by incorporating location-based conditions and triggers. Users can define these triggers, including detailed attributes, either during the creation of content or in advance, offering a versatile mechanism for regulating the accessibility of Evers Contents based on specific geographical or virtual locations within the Evers ecosystem.

8. Secret: As per claim 1, an additional method for regulating the delivery conditions of Evers Contents and ensuring authentication, security, and controlled delivery is through a mechanism known as Evers Secrets. These are custom questions, puzzles, games, challenges or any user-created elements, either in advance or during the creation of Evers Content, facilitated by the Secret section of the Evers Platform and governed by AI.

9. As per claim 8, Evers Secret comprises:
Evers Secrets function as an added layer of security, introducing questions, games, biometric verifications or puzzles as conditions to control the delivery and access control of Evers Contents, essentially operating as smart contract conditions;
user-Created Puzzles, where users leverage the Evers Platform and Artificial Intelligence to devise various puzzles, incorporating different question types, answers, answer types, and difficulty levels. This customization allows for a tailored and secure approach to content delivery, while AI Agent assists with validating Secrets answered by Receivers;
wherein, Secrets may be automatically generated through AI algorithms, utilizing user inputs, machine learning, or information available within the Evers Ecosystem/Platform. This automated generation ensures a dynamic and adaptive approach to securing content delivery;
wherein, Evers Secrets, with its user-created and AI-generated elements, provides a multifaceted method for enhancing security and controlling the delivery conditions of Evers Contents. The integration of questions, puzzles, and other user-defined parameters adds an additional dimension to the secure and authenticated transfer of content within the Evers ecosystem.

10. Act: In alignment with claim 1, an additional method for managing the delivery conditions of Evers Contents involves the use of Evers Acts. These acts serve as triggers to control various actions and conditions within the Evers Platform, influencing the delivery conditions of Evers Contents. Evers Acts are accessible to users and AI Everself offer control over a spectrum of actions, including Evers Future Unity, Future Moments, Evers Secrets, Evers Spots, Evers Links, or other Evers Operations Conditions and Actions that require user or AI inputs or actions.

11. As per claim 10, Evers Act comprises:
control Over Multiple Actions, where Evers Acts empower users with the ability to influence and control various actions and conditions within the Evers Platform;
versatility in Application, where users or AI can utilize Evers Acts to regulate Future Unity, Evers Secrets, Evers Spots, Evers Links, Evers Moments, or other Evers Operations and Conditions, thereby offering a versatile mechanism for content delivery condition control;
Everself also can Create or Control Evers Acts, where the control and execution of Acts are managed by the user's Everself, the AI entity created from the user's data, assets and instructions;
Data-Driven Control, The actions and conditions influenced by Evers Acts are based on the data provided by the user, ensuring a personalized and data-driven approach to content delivery control. User or Everself can create and delegate Evers Act to other user or AI Everslef to control or provide input into conditions and Instructions that are utilized by the same Evers user or other Evers users, as well Eveself of the same or another user.

12. Unique: As per claim 1, a pod possesses the capability to encompass a smart contract-capable digital asset entity referred to as Evers Unique. This entity is created from the user's digital data on Evers Blockchain Network and paid for using Evers Coin and can also have a verified type known as Evers Verified Unique. Evers Verified Unique is created when the Unique is created after the review and approval of documents by professionals such as lawyers, doctors, accountants, or other verifiers or Authorized AI. These approved documents are stored as Verified Documents within the pod.

13. As per claim 12, Evers Unique and Evers Verified Unique comprise:
Smart Contract Capability, where both Evers Unique and Evers Verified Unique entities are equipped with smart contract capabilities, enabling them to be monitored and governed by AI/Everself based on user-defined conditions and quantum-proved algorithms;
a Verification Process, where Evers Verified Unique involves a verification process wherein professionals or Authorized AI verify and approve documents, adding verification, Legality, authenticity and reliability to the Evers Verified Unique ;
AI Governance, where The governance and monitoring of Evers Unique and Evers Verified Unique assets creation and verification are carried out by AI/Everself, aligning with the conditions set by the user, through the authority given to AI and Everself;
the creation of Evers NFTs (Non-Fungible Tokens) is facilitated from Uniques, Verified Uniques, and any digital content stored in the user's Evers Vault cloud storage. This extends the user's ability to tokenize and represent various digital assets within the Evers ecosystem.

14. Evers Coin: In accordance with claim 1, the pod is designed to accommodate the Evers Platform Digital asset cryptocurrency token known as Evers Coin. This cryptocurrency operates as a blockchain multi-chain smart contract token on the Evers Blockchain Network. Users and AI or Everself have the opportunity to earn (mine) Evers Coin as a reward for engaging in diverse activities within the Evers ecosystem. Additionally, users or AI can purchase Evers Coin using fiat currency or other cryptocurrencies.

15. As per claim 14, Evers Coin comprises:
a reward mechanism, where users or AI Everself can earn Evers Coin as a reward for participating in various activities within the Evers ecosystem, fostering user engagement and contributions;
purchase Options, where Evers Coin is available for purchase using fiat currency or other cryptocurrencies, providing users with flexibility in acquiring the Evers digital asset;
utility as native cryptocurrency, where Evers Coin functions as the native cryptocurrency token of the Evers platform, allowing users and Everself AI to utilize it as a means of payment for services offered within the Evers ecosystem and other Web3 platforms. Evers Coin can be stored and transferred in Pod, Chat and other channels in the Evers ecosystem as an Evers content and used to mint Unique or NFT or Paid for verification;
AI-Managed Allocation, where the allocation of Evers Coin, based on usage and security considerations within the blockchain ecosystem, is managed by AI. This ensures a dynamic and adaptive approach to coin distribution.

16. Space: According to claim 1, a notable feature of the described system is Evers Space, an integral part of the Evers Ecosystem/Platform, accessible from connected devices. Evers Space serves as a feature for data pods that host on Multidimensional space, each capable of containing a diverse range of content. These Evers Space contents are capable of becoming available on a specific position on the user's screen, Virtual Reality Locations, or User IoT device, either at a designated time or when specific conditions and instructions set by the Evers Space Post creators like user or Everself AI are met.

17. AS per claim 16, Evers Space comprises:
multi-dimension content delivery position, where Evers Space accommodates a range of Multidimensional Pod, versatile containers capable of holding a wide array of content types;
position-based display, where the content within multidimensional Evers pod or post appears at specified locations on the user's screen, in Virtual Reality, or linked IoT devices, with the appearance triggered and actioned by predetermined conditions or Instructions set by the Evers Space creator user or Everself AI;
multiple space types, where users can have various Evers Spaces, including Public Space, Private Space, or Hybrid Space based on the privacy condition of the Space to receive data, pod and contents. Each space may be associated with a connected IoT enabled device or Drone communicating with the Evers Platform and ecosystem;
Evers Space privacy, visibility and permissions, allow in Private Spaces, to have other users, Everself AI, connections, followers, or friends of the space owner to post content, while in Public Spaces, the space owner or Everself AI can share content for viewing by other users. Hybrid Spaces allow selected users, groups, and connections to both post and view content based on the privacy access levels and permissions;
location of delivery, where Evers Space has a location instruction for delivery, managed by AI/Everself. This implies that the AI entity governs the spatial distribution and delivery of Evers content within Evers Spaces in Virtual Reality or Mixed Reality.

18. MetEvers: In alignment with claim 1, a notable feature of the system is MetEvers—a virtual Web3 universe that users and Everslef have the ability to pre-create by providing instructions for future generations actions. MetEvers is designed as a Web 3.0 platform and can exist in virtual reality, mixed reality or the physical world actual reality. It serves as a dynamic virtual location where Evers users and Everself AI can access Evers Contents and engage with the Evers Platform within a virtual, augmented, or actual reality setting.

19. As per claim 18, MetEvers comprises:
user-created universe, where users have the capability to plan and instruct Everself to create MetEvers in the future, allowing for personalized and user-generated custom virtual environments;
Web 3.0 platform, wherein MetEvers is built as a Web 3.0 platform, incorporating advanced technologies to enhance user experience and interaction within the virtual universe;
access to Evers functionalities, where users and AI within MetEvers can seamlessly access and utilize all Evers functionalities, such as creating and distributing Pods, Chats, and Spaces, or Interact with AI extending the Evers experience to the virtual realm;
communication with digital identities, wherein MetEvers enables users and Everself to communicate with digital identities, including Everself, AI Agents and Clones within the virtual reality platform, fostering immersive and interactive engagements;
planned architectures and structures, wherein certain aspects of MetEvers, including architecture, structures, gravity laws and AI Agents and identities, may be pre-planned by users or AI Everself to be later crafted and managed by the system in the MetEvers. These plans can be generated or modified based on specific Instructions, conditions, times or events, allowing for dynamic and adaptive virtual environments.
